(19) United States
(12) Patent Application Publication
(10) Pub. No.: US 2024/0401745 A1
(43) Pub. Date: Dec. 5, 2024

(54) MOBILE OFF-ROAD HYDROGEN FUELING MACHINE OR TRAILER

(71) Applicant: Caterpillar Inc., Peoria, IL (US)

(72) Inventors: William Christopher BOLEY, Dunlap, IL (US); Steven Louis PARENTE, Tyrone, GA (US); Seth Michael OST, Tucson, AZ (US); Philip F. LANGE, Washington, IL (US); Evan L. FOSTER, Metamora, IL (US); Joel Scott JOHNSON, Washington, IL (US); Robert J. TEMPLE, Peoria Heights, IL (US)

(73) Assignee: Caterpillar Inc., Peoria, IL (US)

(21) Appl. No.: 18/203,344

(22) Filed: May 30, 2023

(51) Int. Cl. F17C 7/04; H01M 8/04082; H01M 8/04089

(52) U.S. Cl. CPC F17C 7/04; H01M 8/04089; H01M 8/04208; F17C 2205/0157; F17C 2205/0376; F17C 2221/012; F17C 2223/0161; F17C 2227/0135; F17C 2227/0337; F17C 2265/065; F17C 2270/0171; F17C 2270/0184; H01M 2008/1095

(57) ABSTRACT

Typically, the refueling process for a mobile hydrogen-powered machine involves driving or otherwise moving the machine to the location of a fixed, stationary hydrogen refueling station, and replenishing the hydrogen storage of the machine at the refueling station. Disclosed embodiments eliminate or reduce the need to transport hydrogen-powered machines to refueling stations. In particular, disclosed embodiments comprise mobile refueling stations that can be transported to remote work locations within an industrial environment. These mobile refueling stations may comprise their own power sources, and may also comprise a grounding rod for safety.

### TECHNICAL FIELD

The embodiments described herein are generally directed to refueling of hydrogen-powered machines in industrial contexts, and, more particularly, to processes and systems for bringing fuel to hydrogen-powered machines at remote locations.

### BACKGROUND

Some work machines are powered by hydrogen. For example, such a machine may be powered by a hydrogen fuel cell. The hydrogen-powered machine may require liquid or gaseous hydrogen, depending on the type of storage on the hydrogen-powered machine.

Traditionally, the refueling process for a mobile hydrogen-powered machine involves driving or otherwise moving the machine to the location of a hydrogen refueling station, and replenishing the hydrogen storage of the machine at the refueling station. U.S. Pat. No. 8,069,885 describes an example of a hydrogen refueling station.

In some industrial contexts, such as construction, mining, farming, forestry, and the like, hydrogen-powered machines may operate in remote locations, such as off-road locations, where no supporting infrastructure exists. Generally, a mobile work machine has a very low track or moving speed for off-road operations, and therefore, requires significant time to travel to the refueling station.

Accordingly, a mobile refueling system, which is capable of traveling to and refueling the hydrogen-powered machine, would offer a variety of benefits. Chinese Publication No. 113090943 and U.S. Pat. No. 7,178,565 describe examples of mobile refueling systems. The present disclosure is directed toward overcoming one or more of the problems discovered by the inventor.

### SUMMARY

In an embodiment, a mobile hydrogen fuel supply system comprises: a mobile platform; at least one storage tank supported on the mobile platform, wherein the at least one storage tank is configured to store liquid hydrogen; a hydrogen dispenser supported on the mobile platform; a cryogenic pump supported on the mobile platform and configured to pump the liquid hydrogen from the at least one storage tank along a flow path to the hydrogen dispenser; and a grounding rod configured to raise and lower, wherein, when the grounding rod is lowered, the grounding rod forms an electrical path from at least the at least one storage tank, the hydrogen dispenser, and the cryogenic pump to a ground.

In an embodiment, a mobile hydrogen fuel supply system comprise: a mobile platform; at least one storage tank supported on the mobile platform, wherein the at least one storage tank is configured to store liquid hydrogen; a liquid hydrogen dispenser supported on the mobile platform; and a cryogenic pump supported on the mobile platform and configured to pump the liquid hydrogen from the at least one storage tank to the liquid hydrogen dispenser.

In an embodiment, a mobile hydrogen fuel supply system comprises: a mobile platform; at least one storage tank supported on the mobile platform, wherein the at least one storage tank is configured to store liquid hydrogen; a cryogenic pump supported on the mobile platform; a vaporizer supported on the mobile platform; a gas storage supported on the mobile platform; and a gaseous hydrogen dispenser supported on the mobile platform; wherein the cryogenic pump is configured to pump the liquid hydrogen from the at least one storage tank to the vaporizer, wherein the vaporizer is configured to convert the liquid hydrogen, output by the cryogenic pump, into gaseous hydrogen, wherein the gas storage is configured to store the gaseous hydrogen, output by the vaporizer, and wherein the gaseous hydrogen dispenser is configured to dispense the gaseous hydrogen from the gas storage.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a mobile hydrogen fuel supply system, according to an embodiment that dispenses liquid hydrogen;

FIG. 2 illustrates a mobile hydrogen fuel supply system, according to an embodiment that dispenses gaseous hydrogen;

FIG. 3 illustrates a fuel-cell-based power source, according to an embodiment; and

FIG. 4 illustrates a processing system that may be used to implement control processes described herein, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description. In addition, it should be understood that the various components illustrated herein are not necessarily drawn to scale. In other words, the features disclosed in various embodiments may be implemented using different relative dimensions within and between components than those illustrated in the drawings.

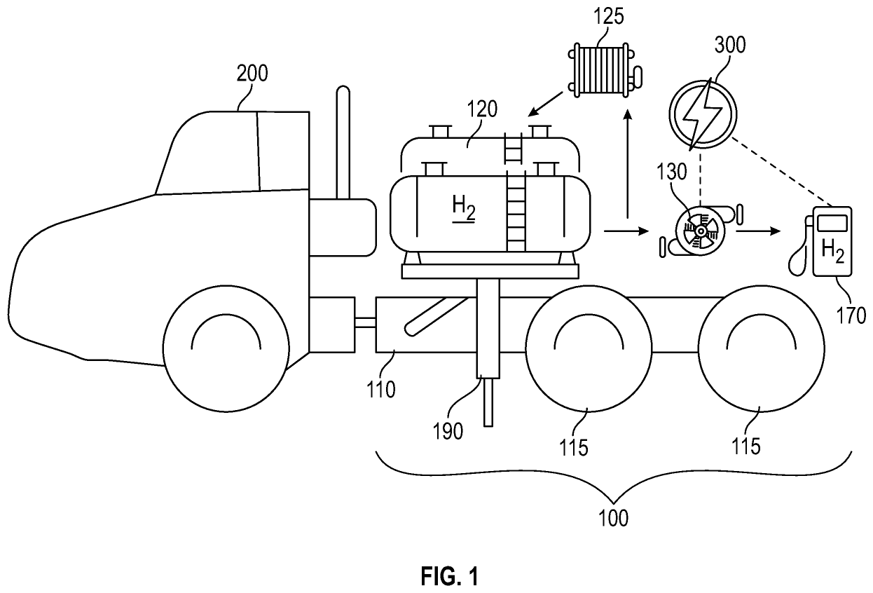

FIG. 1 illustrates a mobile hydrogen fuel supply system 100, according to an embodiment that dispenses liquid hydrogen. Mobile hydrogen fuel supply system 100 comprises a mobile platform 110, which supports a storage tank 120, a pressure build circuit 125, a cryogenic pump 130, a liquid hydrogen dispenser 170, and/or a grounding rod 190. Although only one or two of each component is illustrated, it should be understood that mobile hydrogen fuel supply system 100 may comprise any number of each component, including a plurality of one or more components. Mobile hydrogen fuel supply system 100 may be connected to or integrated into a tractor 200, which moves (e.g., pulls) mobile platform 110 of mobile hydrogen fuel supply system 100. In addition, the electrical components of mobile hydrogen fuel supply system 100 may be powered by a power source 300.

Mobile platform 110 comprises one or more, and preferably a plurality of, ground-engaging members 115, which enable mobile platform 110 to move or be moved relative to the ground. Ground-engaging member(s) 115 may comprise wheels, tracks, or the like. Mobile structure 110 may be an off-road trailer, truck base (e.g., from a flatbed truck, box truck, refrigerated vehicle, tanker truck, lowboy truck, specialty truck, etc.), wheeled tractor scraper base or trailer, wide-body truck base, medium-, heavy-, or severe-duty vocational truck base (e.g., as manufactured by Navistar, Inc. of Lisle, Illinois), or the like. Preferably, mobile structure 110 and ground-engaging member(s) 115 provide a high ground clearance for the bottom of mobile structure 110. However, it should be understood that any structure that is movable and suitable to carry the disclosed components may be used as mobile platform 110.

Each storage tank 120 may be configured to store liquid hydrogen. For example, storage tank 120 may be a cryogenic tank made of stainless steel, designed to store hydrogen at cryogenic temperatures. Cryogenic tanks can hold large amounts of hydrogen, making them suitable for large-scale storage and transportation. Examples of storage tanks that may be used as storage tank 120 include, without limitation, those manufactured by Chart Industries Inc. of Ball Ground, Georgia, Taylor-Wharton America Inc. of Baytown, Texas, Gardner Cryogenics of Bethlehem, Pennsylvania, or the like. It should be understood that disclosed embodiments are not limited to any particular type of storage tank 120. The selection of storage tank 120 may consider factors such as storage capacity, weight, cost, and/or the like.

Each pressure build circuit 125 comprises a regulator, vaporizer, and its respective piping. Pressure build circuit 125 is configured to regulate and maintain pressure for consistent withdrawal of liquid hydrogen from the liquid outlet of storage tank 120. To build pressure, pressure build circuit 125 is brought into service to heat the liquid hydrogen using ambient air. This causes the liquid hydrogen to evaporate and turn into a gas, which is returned to storage tank 120, through a series of pipes and valves, in order to regulate pressure within storage tank 120. Examples of pressure build circuit that may be used as pressure build circuit 125 include, without limitation, those manufactured by Cryomech, Inc. of Syracuse, New York, and Chart Industries Inc.

Each cryogenic pump 130 is configured to pump hydrogen from storage tank 120 to or along a flow path towards liquid hydrogen dispenser 170. When hydrogen is needed, cryogenic pump 130 is activated to pump liquid hydrogen from storage tank 120, through a series of pipes and valves, to liquid hydrogen dispenser 170. Examples of cryogenic pumps that may be used as cryogenic pump 130 include, without limitation, those manufactured by Air Products of Allentown, Pennsylvania, and Linde PLC of Dublin, Ireland.

In an embodiment, pressure build circuit 125 may be used instead of cryogenic pump 130. In this case, cryogenic pump 130 may be omitted. As another alternative, mobile hydrogen fuel supply system 100 may comprise both pressure build circuit 125 and cryogenic pump 130.

Each liquid hydrogen dispenser 170 is configured to receive the liquid hydrogen from cryogenic pump 130, and dispense the liquid hydrogen to one or more machines that are powered by liquid hydrogen. Liquid hydrogen dispenser 170 may comprise one or more connectors that are each configured to pump liquid hydrogen, through a hose to a delivery nozzle, and into an inlet of a fuel tank of the hydrogen-powered machine. Each connector may provide a sealed connection between the delivery nozzle and the inlet to the fuel tank of the hydrogen-powered machine. Examples of liquid hydrogen dispensers that may be used as liquid hydrogen dispenser 170 include, without limitation, those manufactured by Chart Industries Inc.

In an embodiment, mobile hydrogen fuel supply system 100 comprises a grounding rod 190. Grounding rod 190 may be conductively connected to one or more, including potentially all, components of mobile hydrogen fuel supply system 100. Grounding rod 190 may be hydraulic, such that it can be lowered and raised using hydraulics under the control of a control system. Alternatively, grounding rod 190 may be manually lowered and raised, or may be lowered and raised under the control of a control system in some other manner. When lowered to the ground, grounding rod 190 forms an electrical path from the components of mobile hydrogen fuel supply system 100 to the ground, to dissipate static discharge voltage to the earth, thereby grounding the conductively connected components of mobile hydrogen fuel supply system 100. In an embodiment, grounding rod 190 may be configured to be driven at least two meters or six feet into the ground.

Mobile hydrogen fuel supply system 100 may be integrated or connected to a tractor 200. In the event that mobile hydrogen fuel supply system 100 is connected to tractor 200, the connection may be a standard articulating joint, such that mobile hydrogen fuel supply system 100 can rotate within a range of angles with respect to tractor 200. Alternatively, another type of joint, coupling, or attachment may be used.

Tractor 200 may be a vehicle with a cabin, capable of being driven manually by a local or remote human operator, semi-autonomously by a local or remote human operator, and/or autonomously. For example, tractor 200 may comprise a semi-tractor, and mobile platform 110 may be a semi-tractor trailer. Alternatively, tractor 200 may comprise the propulsion system of any work machine manufactured by Caterpillar Inc. of Peoria, Illinois, modified to push or pull mobile hydrogen fuel system 100. The propulsion system may be powered by an internal combustion engine, electric motor, hydrogen fuel cell, or in any other manner.

Mobile hydrogen fuel supply system 100 may be electrically powered by a power source 300. Power source 300 may comprise the battery or engine of tractor 200. Alternatively or additionally, mobile hydrogen fuel supply system 100 may comprise a reciprocating power generator, a fuel cell, an onboard battery, and/or the like, as a power source 300, such that mobile hydrogen fuel supply system 100 can be powered even without tractor 200. In either case, mobile hydrogen fuel supply system 100 will have a reliable source of power, even in remote locations. Alternatively or additionally, power source 300 may comprise a direct electrical connection to a power grid. For example, power source 300 may be a power distribution system, configured to supply power to components of mobile hydrogen fuel supply system 100, with an electrical plug configured for a direct electrical connection to a power grid. It should be understood that power source 300 may consist of any one of these power sources or may comprise any plurality of these power sources.

In an embodiment, mobile hydrogen fuel supply system 100 and/or tractor 200 can be made off-road capable. For example, mobile hydrogen fuel supply system 100 and/or tractor 200 may have a high ground clearance and ruggedized ground-engaging member(s) 115, and may be designed with other features that ensure the safety and stability of storage tank 120 and other components during travel over rough terrains, such as the terrain of a mining, construction, farming, or forestry site, or other industrial environment. These other features may include, without limitation, shock and vibration isolation of components, integral grounding of the components and chassis, heavy duty rated piping and wirings, a low center of gravity to provide stability and prevent tipping, and/or the like.

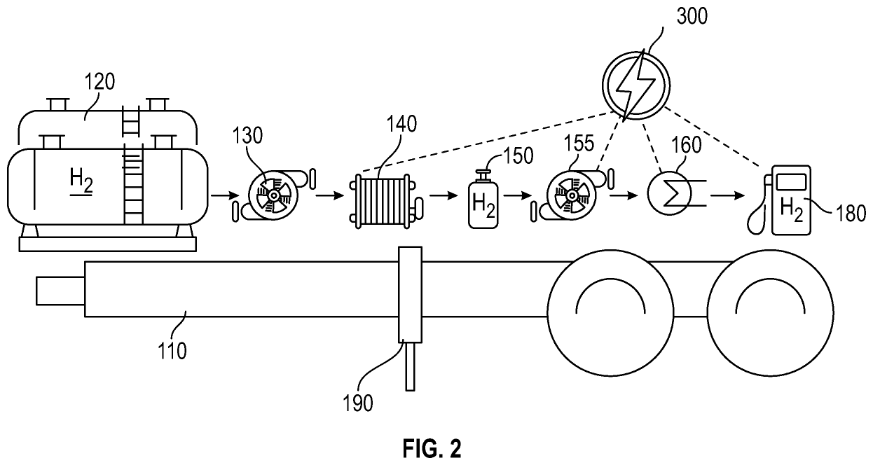

FIG. 2 illustrates a mobile hydrogen fuel supply system 100, according to an embodiment that dispenses gaseous hydrogen. Mobile hydrogen fuel supply system 100 comprises a mobile platform 110, which supports a storage tank 120, a cryogenic pump 130, a vaporizer 140, a gas storage 150, an optional gaseous compressor 155, a gaseous hydrogen dispenser 180, and a grounding rod 190. Although only one or two of each component is illustrated, it should be understood that mobile hydrogen fuel supply system 100 may comprise any number of each component, including a plurality of one or more components. Mobile hydrogen fuel supply system 100 may be connected to or integrated into a tractor 200, which moves (e.g., pulls) mobile platform 110 of mobile hydrogen fuel supply system 100. In addition, the electrical components of mobile hydrogen fuel supply system 100 may be powered by a power source 300.

Mobile platform 110 comprises one or more, and preferably a plurality of, ground-engaging members 115, which enable mobile platform 110 to move or be moved relative to the ground. Each storage tank 120 may be configured to store liquid hydrogen. For example, storage tank 120 may be a cryogenic tank made of stainless steel, designed to store hydrogen at cryogenic temperatures. Each cryogenic pump 130 is configured to pump hydrogen from storage tank 120 to a vaporizer 140. These components may be similar or identical to those that have already been described herein, and therefore, will not be redundantly described herein. When hydrogen is needed, cryogenic pump 130 is activated to pump liquid hydrogen from storage tank 120, through a series of pipes and valves, to vaporizer 140.

Vaporizer 140 receives and converts the liquid hydrogen, pumped from storage tank 120 by cryogenic pump 130, into a gaseous state, enabling it to be dispensed into hydrogen-powered machines that utilize gaseous hydrogen. In particular, vaporizer 140 heats up the liquid hydrogen, causing it to evaporate and become gaseous. Different types of vaporizers 140 may be used, including those that utilize heat exchange, electric resistance, and steam. For example, heat-exchange vaporizers use a hot gas, such as air or nitrogen, to heat up the liquid hydrogen. Examples of vaporizers that may be used as vaporizer 140 include, without limitation, those manufactured by Chart Industries, Proton OnSite of Wallingford, Connecticut, Nel ASA of Oslo, Norway, and Cryostar SAS of Hésingue, France. In combination with cryogenic pump 130, vaporizer 140 is used to provide a continuous supply of gaseous hydrogen to gas storage 150.

Gas storage 150 receives and stores gaseous hydrogen from vaporizer 140, so that it can be immediately dispensed when needed. The hydrogen gas may be compressed before being stored in gas storage 150, which may be designed to safely hold hydrogen gas at pressures of up to 700 bar or higher. Gas storage 150 may be equipped with safety valves and other measures to prevent leaks or explosions. Examples of gas storages that may be used as gas storage 150 include, without limitation, those manufactured by Chart Industries and Praxair, Inc. of Danbury, Connecticut.

For high pressure dispensing, an optional gaseous compressor 155 can be utilized. Gaseous compressor 155 is configured to increase pressure for consistent withdrawal of gaseous hydrogen from gas storage 150. When pressure is low for high pressure dispensing, gaseous compressor 155 may be activated to increase the pressure of gas sent towards gaseous hydrogen dispenser 180. Examples of gaseous compressors that may be used as gaseous compressor 155 include, without limitation, those manufactured by Cryostar SAS of Hésingue, France.

In an embodiment, mobile hydrogen fuel supply system 100 comprises a chiller 160 between gas storage 150 and gaseous hydrogen dispenser 180. Chiller 160 removes heat from the gaseous hydrogen flowing between gas storage 150 and gaseous hydrogen dispenser 180, to thereby cool the gaseous hydrogen. Heat removal may be performed via vapor compression, adsorption refrigeration, or absorption refrigeration cycles. Chiller 160 may be controlled to maintain the gaseous hydrogen at a predefined temperature or within a predefined temperature range (e.g., −20 to −40 degrees Celsius). Thus, chiller 160 is able to dispense ultra-low temperature gaseous hydrogen at high flow rates. Examples of chillers that may be used as chiller 160 include, without limitation, those manufactured by Trenton Refrigeration of Ontario, Canada.

In an embodiment, the pressure of the hydrogen gas, output by vaporizer 140, may be sufficient to cool the hydrogen gas without the need of chiller 160. In this embodiment, chiller 160 may be omitted, such that gas storage 150 is connected directly to gaseous hydrogen dispenser 180.

Each gaseous hydrogen dispenser 180 is configured to receive the gaseous hydrogen from gas storage 150 or chiller 160, and dispense the gaseous hydrogen to one or more machines that are powered by gaseous hydrogen. Gaseous hydrogen dispenser 180 may comprise one or more connectors that are each configured to pump gaseous hydrogen, through a hose to a delivery nozzle, and into an inlet of a fuel tank of the hydrogen-powered machine. Each connector may provide a sealed connection between the delivery nozzle and the inlet to the fuel tank of the hydrogen-powered machine. Examples of liquid hydrogen dispensers that may be used as liquid hydrogen dispenser 180 include, without limitation, those manufactured by Air Products, Plug Power Inc. of Latham, New York, WEH Technologies Inc. of Katy, Texas, and Haskel of Burbank, California.

Mobile hydrogen fuel supply system 100 may comprise a grounding rod 190, may be integrated or connected to a tractor 200, and/or may be electrically powered by a power source 300. These components may be similar or identical to those that have already been described herein, and therefore, will not be redundantly described herein.

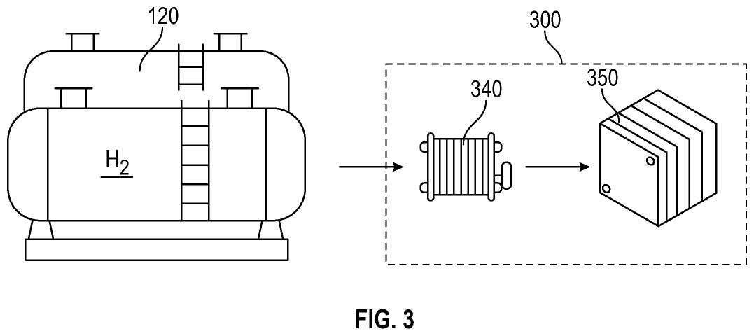

FIG. 3 illustrates a fuel-cell-based power source 300, according to an embodiment. Fuel-cell-based power source 300 comprises a secondary vaporizer 340 and a hydrogen fuel cell 350. Secondary vaporizer 340 receives liquid hydrogen from storage tank 120. Although only one or two of each component is illustrated, it should be understood that fuel-cell-based source 300 may comprise any number of each component, including a plurality of one or more components. Fuel-cell-based power source 300 may be connected to or integrated into mobile hydrogen fuel supply system 100.

Similarly or identically to vaporizer 140, secondary vaporizer 340 receives and converts liquid hydrogen from storage tank 120 into a gaseous state, enabling it to be used as fuel. In particular, secondary vaporizer 340 heats up the liquid hydrogen, causing it to evaporate and become gaseous. Secondary vaporizer 340 is used to provide a continuous supply of gaseous hydrogen to hydrogen fuel cell 350. Secondary vaporizer 340 may be similar or identical to vaporizer 140, and therefore, will not be redundantly described herein.

Hydrogen fuel cell 350 converts the gaseous hydrogen received from secondary vaporizer 340 into electricity. Hydrogen fuel cell 350 is an electrochemical device that converts the chemical energy of hydrogen fuel and oxygen into electrical energy. The process of converting hydrogen gas into electricity occurs when the hydrogen gas is supplied by secondary vaporizer 340 to the anode of hydrogen fuel cell 350. At the anode, hydrogen molecules are split into protons and electrons through a process called electrolysis. This reaction is facilitated by a catalyst, typically made of platinum. The protons travel through a proton exchange membrane (PEM) that separates the anode from the cathode, while the electrons are forced to take a different path, creating a flow of electrons, or current. The movement of the electrons generates an electrical current that can be used to power any of the components of mobile hydrogen fuel supply system 100, such as cryogenic compressor 130, vaporizer 140, chiller 160, and/or liquid hydrogen dispenser 170 or gaseous hydrogen dispenser 180. Examples of fuel cells that may be used as fuel cell 350 include, without limitation, Ballard Power of Burnaby, Canada, Hyzon Motors of Rochester, New York, Refire of Shanghai, China, and Bosch SOFC of Stuttgart-Feuerbach, Germany.

In an alternative embodiment in which power source 300 utilizes a reciprocating power generator, power source 300 may be constructed in a similar or identical manner, except that hydrogen fuel cell 350 is replaced with a reciprocating power generator. In other words, power source 300 may comprise a secondary vaporizer 340 that provides a continuous supply of gaseous hydrogen to the reciprocating power generator. The reciprocating power generator may use the expansion of the gaseous hydrogen to drive one or more pistons that rotate a crankshaft to generate power.

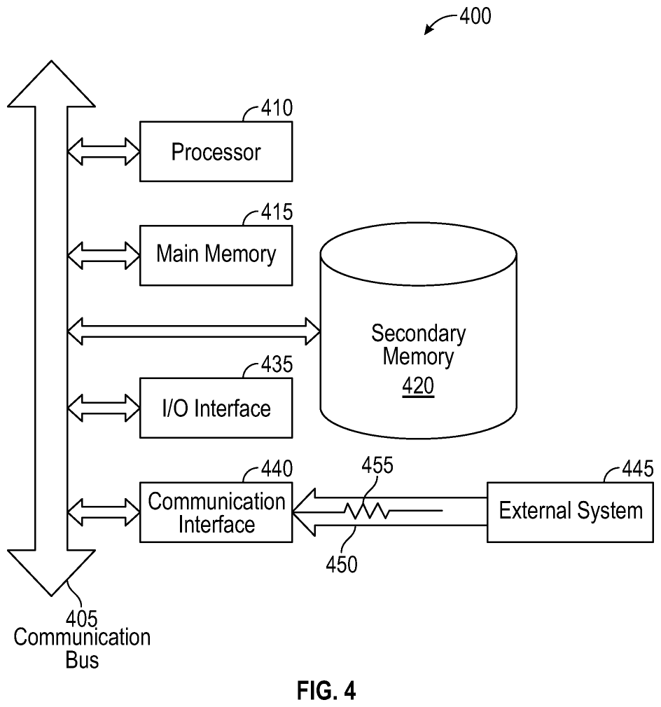

FIG. 4 illustrates an example processing system 400 that may be used as controller to control one or more of the electronic devices described herein. For example, processing system 400 may be communicatively coupled to one or more of cryogenic compressor 130, vaporizer 140, chiller 160, liquid hydrogen dispenser 170, gaseous hydrogen dispenser 180, grounding rod 190, vaporizer 340, and/or fuel cell 350. As an example, processing system 400 may control the raising and lowering of ground rod 190, verify that mobile hydrogen fuel supply system 100 is grounded, turn on, turn off, and/or change the operating mode or other configuration of cryogenic pump 130, vaporizer 140, chiller 160, liquid hydrogen dispenser 170, gaseous hydrogen dispenser 180, vaporizer 340, fuel cell 350, and/or the like, configure one or more valves between the various components, and/or the like. Each controlled component of mobile hydrogen fuel supply system 100 may comprise its own processing system 400, or a single processing system 400 may control all components or a subset of components of mobile hydrogen fuel supply system 100.

System 400 may comprise one or more processors 410. Processor(s) 410 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 410. Examples of processors which may be used with system 400 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 410 may be connected to a communication bus 405. Communication bus 405 may include a data channel for facilitating information transfer between storage and other peripheral components of system 400. Furthermore, communication bus 405 may provide a set of signals used for communication with processor 410, including a data bus, address bus, and/or control bus (not shown). Communication bus 405 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 400 may comprise main memory 415. Main memory 415 provides storage of instructions and data for programs executing on processor 410, such as one or more of the control functions discussed herein. It should be understood that programs stored in the memory and executed by processor 410 may be written and/or compiled according to any suitable language, including without limitation C/C++, Java, JavaScript, Perl, Python, Visual Basic,.NET, and the like. Main memory 415 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 400 may comprise secondary memory 420. Secondary memory 420 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 400. The computer software stored on secondary memory 420 is read into main memory 415 for execution by processor 410. Secondary memory 420 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

System 400 may comprise an input/output (I/O) interface 435. I/O interface 435 provides an interface between one or more components of system 400 and one or more input and/or output devices. For example, I/O interface 435 may receive the output of one or more sensors (e.g., a pressure sensor of cryogenic pump 130, a pressure sensor of vaporizer 140, a temperature sensor of chiller 160, etc.), and/or output control signals to one or more components of mobile hydrogen fuel supply system 100.

System 400 may comprise a communication interface 440. Communication interface 440 allows software to be transferred between system 400 and external devices, networks, or other information sources. For example, computer-executable code and/or data may be transferred to system 400, over one or more networks, from a network server via communication interface 440. Examples of communication interface 440 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 400 with a network or another computing device. Communication interface 440 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 440 is generally in the form of electrical communication signals 455. These signals 455 may be provided to communication interface 440 via a communication channel 450 between communication interface 440 and an external system 445. In an embodiment, communication channel 450 may be a wired or wireless network, or any variety of other communication links. Communication channel 450 carries signals 455 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 415 and/or secondary memory 120. Computer-executable code can also be received from an external system 445 via communication interface 440 and stored in main memory 415 and/or secondary memory 420. Such computer-executable code, when executed by processor(s) 410, enable system 400 to perform the various control functions of the disclosed embodiments.

### INDUSTRIAL APPLICABILITY

In some industrial contexts, hydrogen-powered work machines may operate in remote locations, including off-road locations. It takes significant time for these work machines to travel to a refueling station to replenish their supplies of hydrogen fuel. Accordingly, disclosed embodiments provide a mobile hydrogen fuel supply system 100 that is capable of traveling to the remote locations of these hydrogen-powered work machines, to replenish their supplies of hydrogen fuel on site.

Mobile hydrogen fuel supply system 100 may be powered at a remote location using a power source 300, which may include the battery or engine of tractor 200, a reciprocating power generator, a fuel cell, an onboard battery, or a direct electrical connection to a power grid or other power supply. Power source 300 may power the components of mobile hydrogen fuel supply system 100, including cryogenic pump 130, vaporizer 140, chiller 160, liquid hydrogen dispenser 170, gaseous hydrogen dispenser 180, and/or grounding rod 190, such that mobile hydrogen fuel supply system 100 is able to operate at the remote location. Mobile hydrogen fuel supply system 100 may be fixed to or integrated with a tractor 200 and may be ruggedized for off-road travel, so that it can be operated as a vehicle to be driven to any remote location as needed. At the remote location, ground rod 190 may be deployed (e.g., lowered into the ground) to ground the electric components of mobile hydrogen fuel supply system 100 for safety.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of industrial context or with a particular type of hydrogen-powered machine. Hence, although the present embodiments are, for convenience of explanation, depicted and described as being implemented with hydrogen-powered work machines, it will be appreciated that it can be implemented for various other types of hydrogen-powered machines, and in various other environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A mobile hydrogen fuel supply system comprising:
a mobile platform;
at least one storage tank supported on the mobile platform, wherein the at least one storage tank is configured to store liquid hydrogen;
a hydrogen dispenser supported on the mobile platform; and
a grounding rod configured to raise and lower, wherein, when the grounding rod is lowered, the grounding rod forms an electrical path from at least the at least one storage tank and the hydrogen dispenser to a ground.

2. The mobile hydrogen fuel supply system of claim 1, further comprising one or both of:
a cryogenic pump supported on the mobile platform and configured to pump the liquid hydrogen from the at least one storage tank along a flow path to the hydrogen dispenser; and
a pressure build circuit configured to build pressure in the at least one storage tank.

3. The mobile hydrogen fuel supply system of claim 1, wherein the hydrogen dispenser is configured to dispense liquid hydrogen.

4. The mobile hydrogen fuel supply system of claim 1, wherein the hydrogen dispenser is configured to dispense gaseous hydrogen.

5. The mobile hydrogen fuel supply system of claim 4, further comprising a vaporizer, positioned between the at least one storage tank and the hydrogen dispenser, wherein the vaporizer is configured to convert the liquid hydrogen into gaseous hydrogen.

6. The mobile hydrogen fuel supply system of claim 5, further comprising a gas storage between the vaporizer and the hydrogen dispenser, wherein the gas storage is configured to store the gaseous hydrogen output by the vaporizer.

7. The mobile hydrogen fuel supply system of claim 6, further comprising a chiller between the gas storage and the hydrogen dispenser, wherein the chiller is configured to cool the gaseous hydrogen output by the gas storage.

8. The mobile hydrogen fuel supply system of claim 1, wherein the mobile hydrogen fuel supply system further comprises a power source that is electrically connected to one or more of the hydrogen dispenser, the cryogenic pump, or the grounding rod.

9. The mobile hydrogen fuel supply system of claim 1, wherein the power source comprises a reciprocating power generator and a vaporizer between the at least one storage tank and the reciprocating engine, wherein the vaporizer is configured to convert the liquid hydrogen into gaseous hydrogen.

10. The mobile hydrogen fuel supply system of claim 1, wherein the power source comprises a fuel cell and a vaporizer between the at least one storage tank and the fuel cell, wherein the vaporizer is configured to convert the liquid hydrogen into gaseous hydrogen.

11. The mobile hydrogen fuel supply system of claim 1, further comprising a power distribution system with an electrical plug configured for a direct electrical connection to a power grid, wherein the power distribution system is configured to supply power to one or more of the hydrogen dispenser, the cryogenic pump, or the grounding rod.

12. The mobile hydrogen fuel supply system of claim 1, further comprising a control system that verifies that the at least one storage tank and the hydrogen dispenser are grounded.

13. A system comprising:
the mobile hydrogen fuel supply system of claim 1; and
a tractor connected to the mobile hydrogen fuel supply system and configured to pull the mobile hydrogen fuel supply system.

13. A system of claim 13, wherein the tractor comprises a power source that is electrically connected to one or both of the hydrogen dispenser or the grounding rod.

15. A mobile hydrogen fuel supply system comprising:
a mobile platform;
at least one storage tank supported on the mobile platform, wherein the at least one storage tank is configured to store liquid hydrogen;
a liquid hydrogen dispenser supported on the mobile platform; and
a cryogenic pump supported on the mobile platform and configured to pump the liquid hydrogen from the at least one storage tank to the liquid hydrogen dispenser.

16. The mobile hydrogen fuel supply system of claim 15, further comprising a grounding rod configured to form an electrical path from the mobile platform to the a ground.

15. The mobile hydrogen fuel supply system of claim 15, wherein the mobile hydrogen fuel supply system further comprises a power source that is electrically connected to one or both of the liquid hydrogen dispenser or the cryogenic pump.

18. The mobile hydrogen fuel supply system of claim 17, wherein the power source comprises:
a fuel cell or a reciprocating power generator; and
a vaporizer between the at least one storage tank and the fuel cell or reciprocating power generator, wherein the vaporizer is configured to convert the liquid hydrogen into gaseous hydrogen.

19. A mobile hydrogen fuel supply system comprising:
a mobile platform;
at least one storage tank supported on the mobile platform, wherein the at least one storage tank is configured to store liquid hydrogen;
a cryogenic pump supported on the mobile platform;
a vaporizer supported on the mobile platform;
a gas storage supported on the mobile platform; and
a gaseous hydrogen dispenser supported on the mobile platform;
wherein the cryogenic pump is configured to pump the liquid hydrogen from the at least one storage tank to the vaporizer,
wherein the vaporizer is configured to convert the liquid hydrogen, output by the cryogenic pump, into gaseous hydrogen,
wherein the gas storage is configured to store the gaseous hydrogen, output by the vaporizer, and
wherein the gaseous hydrogen dispenser is configured to dispense the gaseous hydrogen from the gas storage.

20. The mobile hydrogen fuel supply system of claim 19, further comprising a grounding rod configured to form an electrical path from the mobile platform to a ground.
